(19) United States
(12) Patent Application Publication
(10) Pub. No.: US 2021/0276299 A1
(43) Pub. Date: Sep. 9, 2021

(54) Vehicle PU composite component comprising a layered construction having a honeycomb structure

(71) Applicant: Webasto SE, Stockdorf (DE)

(72) Inventors: Matthias BAUMANN, Stockdorf (DE); Frank KIESEWETTER, Stockdorf (DE); Matthias ALTENDORFNER, Stockdorf (DE); Bernd DÜRMAYER, Stockdorf (DE)

(21) Appl. No.: 17/054,059

(22) PCT Filed: Jun. 11, 2019
(86) PCT No.: PCT/EP2019/065191

§ 371 Date: Nov. 9, 2020

(30) Foreign Application Priority Data
Jun. 25, 2018 (DE) 10 2018 115 241.8

(51) Int. Cl. B32B 3/12; B32B 5/14; B32B 5/18; B29C 44/12; B29C 44/36

(52) U.S. Cl. CPC B32B 3/12; B32B 5/142; B60J 7/00; B29C 44/12; B29C 44/367; B32B 5/18

(57) ABSTRACT

A vehicle PU composite component having a layered construction having a honeycomb structure, the honeycomb structure being reinforced by PU material, and the layered construction or the component being formed from PU material and having at least one component elevation. The component elevation PU material forming the component elevation differs from the honeycomb structure PU material reinforcing the honeycomb structure, and in that the component elevation PU material has a higher foaming degree having lower material density as compared to the honeycomb structure PU material. A method for producing a vehicle PU composite component having a layered construction having a honeycomb structure.

The invention relates to a vehicle PU composite component with a layered construction having a honeycomb structure, wherein the honeycomb structure is reinforced with PU material, and the layered construction or the component is formed with at least one component elevation composed of PU material, and also to a method for producing a vehicle PU composite component with a layered construction having a honeycomb structure.

Such a vehicle PU composite component is for example a cover of a roof opening system, such as a sliding roof or a spoiler roof, a surface component of a roof module, a trim component of a vehicle or else a parcel shelf or a sliding headliner.

In vehicle construction, vehicle PU composite components are usually embodied as areal components having uniform component thickness. This applies in particular for components such as parcel shelves, sliding headliners or entire vehicle roofs. A core structure of these components is manufactured by means of a homogeneous honeycomb core typically having constant honeycomb thickness. For components with increased strength requirements or design-defined contours, such as, for example, convertible roof arches or areal roof arches of an RHT (retractable hard top) roof, which have large variations in thickness, it is not possible to use honeycombs having constant thickness. In these components, particularly thin cross sections are required specifically in the component edge region, whereas large thicknesses are required in the inner region of the component. Correspondingly, the honeycombs have to be subjected to complex mechanical machining, since otherwise there is the risk that the honeycomb parts which are compressed in the method may swell in the edge region on account of excessively low plastic penetration, in particular as a result of the action of moisture.

Furthermore, it is known, for example from US 2007/0164131 A1, to form PU composite components in that a uniform polyurethane is applied on both sides of a honeycomb structure which is covered on both sides with fiber mats, and said polyurethane is pressed into form in a tool and baked or cured at elevated temperature.

Changes of the component shape with variations in geometry in the z direction or thickness direction are generally formed in that additional adhesive in the form of the same polyurethane material is applied onto the layered construction or the PU composite, and in that the component elevations are thereby formed.

However, this additional application of polyurethane has the disadvantage that, as a consequence of this local material accumulation, considerably more polyurethane material is required for the production of the components. As a result, the component costs and the component weight increase greatly. Overall, as a result, the 3D shapeability of the component is greatly limited and the required reworking of the component is greatly increased.

The invention is based on the object of providing a vehicle PU composite component, mentioned in the introduction, which is simplified and improved with regard to its production outlay, and also of specifying a method for producing such a vehicle PU composite component.

In the case of the vehicle PU composite component mentioned in the introduction, this object is achieved according to the invention in that the component elevation PU material forming the component elevation differs from the honeycomb structure PU material reinforcing the honeycomb structure, and in that the component elevation PU material has a higher degree of foaming with lower material density compared with the honeycomb structure PU material.

Furthermore, the object is achieved by a method, as claimed in claim 10, for producing a vehicle PU composite component with a layered construction having a honeycomb structure, in particular as claimed in one of claims 1 to 9, said method having the steps of:

a) providing a honeycomb structure which is provided or reinforced with PU material, and

b) applying a component elevation PU material, which differs from the honeycomb structure PU material, onto the honeycomb structure in order to form an in particular frame-like or rib-like component elevation.

Advantageous configurations of the invention are specified in each case in the dependent claims.

By virtue of the fact that the component elevation PU material differs from the honeycomb structure PU material, it is possible to use a polyurethane material which is specifically adapted for the production of the at least one component elevation. According to the invention, provision is made for the component elevation PU material to have a higher degree of foaming with lower material density compared with the honeycomb structure PU material. It is thus possible to reduce the additional consumption, which would otherwise occur, of PU material for the variations in geometrical thickness or at the component regions having increased thickness. The degree of forming—that is to say the ability of the PU material to be able to be adapted to large changes in thickness or variations in thickness in the tool—can also be considerably improved if the degree of foaming of the polyurethane is considerably increased.

The component properties and in particular the overall stiffness of the component can thus also be maintained if the two different PU materials are used in combination in a component. The conventional application of PU onto the honeycomb structure is maintained, and additional PU is used in the regions with large variations in geometrical thickness or else a really by way of a more intensely foaming PU system, with simultaneously lower material usage.

As a result of the foaming, the amount of material used for local elevations in the component can be greatly reduced. As a result, the component costs and the component weight are reduced, whereas there is substantially virtually no influence on the rest of the component properties.

The vehicle PU composite component according to the invention is distinguished by further advantages:

Honeycomb structure material can be saved, since the honeycomb structure does not need to have a thickness that corresponds to the thickness of the highest or thickest point of the component at the component elevation. This results in lower production costs and a lower component weight.

It is not necessary to machine the honeycomb structure by milling or sawing. This results in lower production costs.

The honeycomb structure does not need to undergo preliminary pressing. This also results in lower production costs.

On account of a lower compression of the honeycomb structure, fewer imprints can be produced on a class A surface, as a result of which the component quality is increased.

With equal filling of the component with polyurethane, it is possible to use less PU.

In principle, larger variations in thickness can be produced in the component in a simple manner as a result of these component elevations.

The density of the component or of the at least one component elevation can be set differently in certain regions, such that it is possible to realize predetermined breaking points or reinforcements, for example.

The component elevation can form a rib-like reinforcement of the component, and in particular a peripheral frame-like reinforcement. However, other regions of the component can also be formed as thickened portions or reinforcements by application of material, such as, for example, areal component elevations which are in particular central on the component.

Expediently, the component elevation PU material is applied on the honeycomb structure PU material. Accordingly, the honeycomb structure is initially completely reinforced with the honeycomb structure PU material.

However, the honeycomb structure can also be reinforced with honeycomb structure PU material only up to one region and outside of this region, and that region of the honeycomb structure which is intended to be provided with a component elevation is accordingly also reinforced with component elevation PU material and obtains the additional application of material for the component elevation. Expediently, it can therefore be provided that, in a region of the honeycomb structure, said region being provided for the component elevation, the component elevation PU material is applied instead of the honeycomb structure PU material in order to reinforce the honeycomb structure and in order to form the component elevation.

According to a preferred embodiment, the component elevation is formed by means of spray application of the component elevation PU material. The final shaping of the component elevation and of the component takes place in a closed forming tool by way of forming pressure and elevated temperature for curing the PU material.

It is particularly preferable for the component elevation PU material to have a density in the range of 0.30 g/cm³ to 0.80 g/cm³, preferably of 0.30 g/cm³ to 0.70 g/cm³ and in particular of 0.30 g/cm³ to 0.50 g/cm³. From these different density values, a respective density value is selected for a determined strength to be achieved and for a resultant weight.

Expediently, the component elevation PU material contains an additive, a blowing agent or a stabilizer. As a result of addition of at least one of these agents, the degree of foaming can be improved and the foaming can be controlled and in particular accelerated. As blowing agent, use can for example be made of water, which enhances the reactivity.

In a preferred configuration, the honeycomb structure of the vehicle PU composite component is provided with an in particular fiber-reinforced first, upper or inner PU layer and/or an in particular fiber-reinforced second, lower or outer PU layer. This PU layer is expediently formed of the honeycomb structure PU material but can also be formed of the component elevation PU material in particular in the region in which a component elevation is intended to be formed. Expediently, provision can therefore be made for the inner PU layer and/or the outer PU layer to be formed, at least in the region of a component elevation applied thereon, of component elevation PU material.

In the method according to the invention, as claimed in claim 10, for producing a vehicle PU composite component with a layered construction having a honeycomb structure, a honeycomb structure is thus initially provided which is provided or reinforced with PU material, which is referred to as honeycomb structure PU material and which has a determined degree of foaming with corresponding material density. A component elevation PU material, which differs from the honeycomb structure PU material, is subsequently applied onto the honeycomb structure in order to form an in particular frame-like or rib-like component elevation. Different selectable and settable material properties of the polyurethane or of the component elevation PU material make it possible to set properties of the component, such as strength and weight, in a defined manner. It is therefore particularly preferable for the component elevation PU material to be foamed, in particular with addition of an additive, a blowing agent or a stabilizer, with a higher degree of foaming at lower material density compared with the honeycomb structure PU material.

The honeycomb structure can have at least one top layer composed in particular of PU material, said top layer being formed on that side on which the component elevation is attached.

In addition to the advantages specified above with regard to the PU composite component, mention should furthermore be made of increased process reliability in the method sequence on account of the following factors:
lower weight of the PU composite component simplifies the handling, even when robots are used;
the lower PU shot weight makes it possible to reduce the handling time and thus the critical material open time;
an improved edge filling reduces the reworking of complex components.

According to a preferred configuration of the method, provision is made for the component elevation PU material to be sprayed, in particular by means of a spray head of a spraying device, onto the honeycomb structure, or the top layer thereof, which is arranged in particular in an open forming tool, and for the sprayed-on component elevation PU material to be subsequently pressed, in a or the closed forming tool, into the form of the component elevation formed on the honeycomb structure. The component elevation PU material can also be sprayed for example onto both sides of the honeycomb structure outside of the forming tool, for example in a spray booth. The handling and the insertion of the sprayed honeycomb structure into the forming tool is expediently carried out by means of robots.

During the mixing of polyol and isocyanate to provide the PU material, two different polyols are preferably used, wherein the one polyol has a normal free rise density and the second polyol has a free rise density which is reduced by half. In this case, the ratio of the two polyols can be selected as desired.

The invention is explained in more detail below on the basis of one exemplary embodiment of a vehicle PU composite component according to the invention with reference to the drawing, in which:

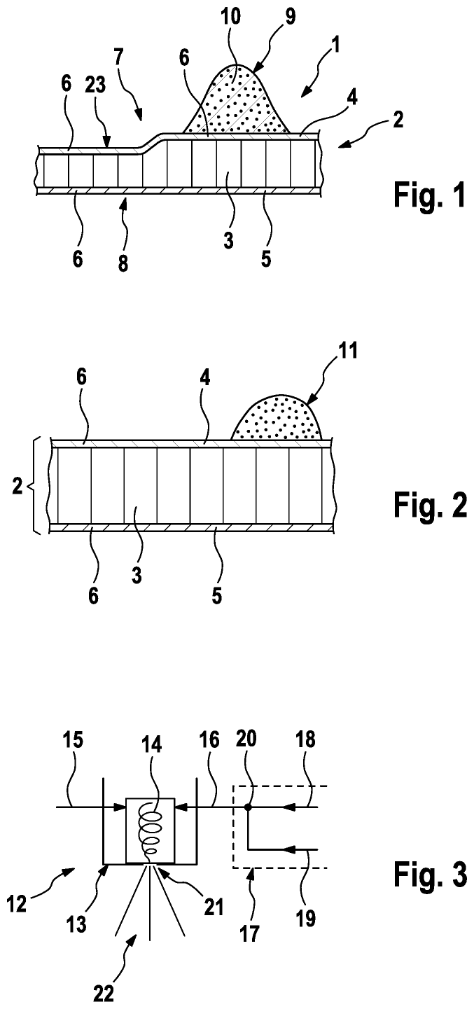

FIG. 1 shows a sectional view of a detail of a PU composite component having a honeycomb structure reinforced with honeycomb structure PU material and having a component elevation formed thereon by applied component elevation PU material;

FIG. 2 shows a sectional view as per FIG. 1 of the honeycomb structure reinforced with honeycomb structure PU material and the component elevation PU material applied thereon prior to the shaping of the PU composite component in a forming tool; and

FIG. 3 shows a schematic illustration of a spraying device for applying PU material.

A vehicle PU composite component 1 (see detail illustration of FIG. 1), such as, for example, a part of a roof module or a cover of an openable roof such as a sliding roof or tilt and slide roof or the like, has a layered construction 2 with a central honeycomb structure 3 as core layer and with top layers 4 and 5, composed of PU material, on both sides, wherein said material reinforcing the honeycomb structure 3 is referred to as PU honeycomb structure material 6. The PU honeycomb structure material 6, which, during the production, may also have penetrated to a selectable depth into the honeycomb structure 3 in order to increase the strength, preferably contains fibers, such as, for example, glass fibers, basalt fibers, carbon fibers or natural fibers, in order to increase the strength of the top layers 4 and 5 and thus of the layered construction 2. In FIG. 1, by way of example, the upper component side with the top layer 4 is the inner side 7 of the component 1 and the lower component side with the top layer 5 is the outer side 8 of the component 1.

On the one or the upper top layer 4 of the honeycomb structure 3, there is formed a component elevation 9 which for example represents a reinforcement of the component 1 in the form of a rib or a frame part. The component elevation 9 is formed of a PU material which is referred to as component elevation PU material 10 and which has material properties that differ from those of the PU honeycomb structure material 6.

The component elevation PU material 10 has in particular a higher degree of foaming and thus a lower material density compared with the honeycomb structure PU material 6. The component elevation PU material 10 can thus have a density in the range of 0.30 g/cm³ to 0.80 g/cm³, preferably of 0.30 g/cm³ to 0.70 g/cm³ and in particular of 0.30 g/cm³ to 0.50 g/cm³.

The lower density of the component elevation PU material 10 brings about a lower weight of the component elevation 9 formed therefrom in comparison with the production of the component elevation 9 with the honeycomb structure PU material 6 used for the top layers 4, 5. The density is selected in such a way that the material and functional properties of the component elevation 9, such as for example of a frame or the like formed therefrom or of an areal elevation of the component 1, are not impaired or are impaired only to an insignificant extent.

FIG. 2 shows the layered construction 2 with the honeycomb structure 3 with the two top layers 4 and 5 formed of honeycomb structure PU material 6 as a semi-finished product prior to the shaping in a forming tool. A raised strip 11 composed of component elevation PU material 10 has been applied onto the upper or inner top layer 4, for example by means of a spray head of a PU-injecting or PU-spraying device 12 (see FIG. 3). During the application of the component elevation PU material 10, the layered construction 2 is located for example in an open forming tool or outside of a forming tool, for example in a spray booth. The component elevation PU material 10 expediently has a viscous consistency, such that a raised strip of this kind can be formed on the semi-finished product and substantially maintains its shape up to insertion into the forming tool.

The spraying device 12, shown in FIG. 3 in a simplified schematic illustration, for applying PU material contains a spray or mixing head 13 with a mixing chamber 14 into which isocyanate, on the one hand, is supplied via a first supply line 15 and polyol, on the other hand, is supplied via a second supply line 16, wherein a calibration block 17 is connected upstream of the second supply line 16, in which calibration block two different polyols or PU constituents, via supply lines 18 and 19, are mixed via a mixing valve 20 and conducted into the mixing chamber 14 via the supply line 16. A PU spray 22 for generating the component elevation PU material 10 exits via a spray opening 21 in the spray or mixing head 13.

The two different polyols or PU constituents have different properties, such that the targeted, controlled mixing thereof makes it possible to generate the component elevation PU material 10 in the respectively required composition and consistency for obtaining the respectively desired degree of foaming or the density.

In the present case, two different polyols are used, wherein, preferably, the one polyol has a normal free rise density and the other polyol has a free rise density which is reduced by half, and the mixing ratio of the two polyols can be selected as desired.

The component 1 present in the shape in FIG. 2 is brought into the form illustrated in FIG. 1 in the forming tool under forming or pressing pressure and with introduction of heat. In addition to the shaping of the component elevation 9, the layered construction 2 can be formed, and additionally also compacted, at least in a determined region 23 as a result of compression at least of the honeycomb structure 3.

The honeycomb or honeycomb structure is preferably produced from paper (paper honeycomb), from aluminum or from a plastic, such as, for example, phenol resin. Honeycomb is also understood to mean, for example, components which run in a wavelike manner or spacers, which run perpendicularly with respect to the outer surfaces of the honeycomb structure, or cell-like structures.

The directional indications “above” and “below”, and also “outside” and “inside”, included in the above description relate merely to the illustration of the exemplary embodiment in the figures and do not limit for example the arrangement of the top layers and of the component elevations.

The individual features of the invention which are disclosed in the description and with reference to the exemplary embodiment as well as in the figures can be combined in any desired technically expedient arrangements and configurations with the subject matter of the invention in its general form.

List of reference designations

| | |
|---|---|
| 1 | Vehicle PU composite component |
| 2 | Layered construction |
| 3 | Honeycomb structure |
| 4 | Top layer |
| 5 | Top layer |
| 6 | PU honeycomb structure material |
| 7 | Inner side |
| 8 | Outer side |
| 9 | Component elevation |
| 10 | Component elevation PU material |
| 11 | Strip |
| 12 | Injecting or spraying device |
| 13 | Spray or mixing head |
| 14 | Mixing chamber |
| 15 | First supply line |
| 16 | Second supply line |
| 17 | Calibration block |
| 18 | Polyol supply line |
| 19 | Polyol supply line |
| 20 | Mixing valve |
| 21 | Spray opening |
| 22 | PU spray |
| 23 | Region |

1. A vehicle PU composite component with a layered construction having a honeycomb structure, wherein the honeycomb structure is reinforced with PU material, and the layered construction or the component is formed with at least one component elevation composed of PU material, wherein the component elevation PU material forming the component elevation differs from the honeycomb structure PU material reinforcing the honeycomb structure, and wherein the component elevation PU material has a higher degree of foaming with lower material density compared with the honeycomb structure PU material.

2. The component as claimed in claim 1, wherein the component elevation forms at least one of an areal elevation or a rib-like reinforcement of the component or a peripheral frame-like reinforcement of the component.

3. The component as claimed in claim 1, wherein the component elevation PU material is applied on the honeycomb structure PU material.

4. The component as claimed in claim 1, wherein, in a region of the honeycomb structure, said region being provided for the component elevation, the component elevation PU material is applied instead of the honeycomb structure PU material in order to reinforce the honeycomb structure and in order to form the component elevation.

5. The component as claimed in claim 1, wherein the component elevation is formed by spray application of the component elevation PU material.

6. The component as claimed in claim 1, wherein the component elevation PU material has a density in the range of 0.30 g/cm³ to 0.80 g/cm³.

7. The component as claimed in claim 1, wherein the component elevation PU material contains at least one of an additive, a blowing agent or a stabilizer.

8. The component as claimed in claim 1, wherein the honeycomb structure has at least one of an fiber-reinforced inner PU layer or a fiber-reinforced outer PU layer.

9. The component as claimed in claim 7, wherein at least one of the inner PU layer or the outer PU layer are formed, at least in the region of a component elevation applied thereon, of component elevation PU material.

10. A method for producing a vehicle PU composite component with a layered construction having a honeycomb structure as claimed in claim 1, comprising the steps of:
a) providing a honeycomb structure which is provided or reinforced with PU material,
b) applying a component elevation PU material which differs from the honeycomb structure PU material, onto the honeycomb structure in order to form a frame-like or rib-like component elevation.

11. The method as claimed in claim 10, wherein the component elevation PU material is foamed with a higher degree of foaming at lower material density compared with the honeycomb structure PU material.

12. The method as claimed in claim 11, wherein the component elevation PU material is foamed with addition of one of an additive, a blowing agent or a stabilizer.

13. The method as claimed in claim 1, wherein the component elevation PU material is sprayed onto the honeycomb structure, and
subsequently pressing the sprayed-on component elevation PU material, in a closed forming tool, into the form of the component elevation formed on the honeycomb structure.

14. The method as claimed in claim 13, wherein the component elevation PU material is sprayed onto the honeycomb structure by a spray head of a spraying device.

15. The method as claimed in claim 13, wherein, during the spraying-on of the component elevation PU material, the honeycomb structure is either arranged in the open forming tool or is arranged in a spray booth outside of the forming tool and is subsequently inserted into the forming tool with the sprayed-on component elevation PU material.

16. The component as claimed in claim 1, wherein the component elevation PU material has a density in the range of 0.30 g/cm³ to 0.70 g/cm³.

17. The component as claimed in claim 1, wherein the component elevation PU material has a density in the range of 0.30 g/cm³ to 0.50 g/cm³.
